(19) United States
(12) Patent Application Publication
(10) Pub. No.: US 2025/0031057 A1
(43) Pub. Date: Jan. 23, 2025

(54) TECHNIQUE FOR CLEARING CONFIGURATIONS AT WIFI EXTENDERS

(71) Applicant: Nokia Solutions and Networks Oy, Espoo (FI)

(72) Inventors: Karthick Rajapandiyan, Chennai (IN); Palaniappan Ramasamy, Chennai (IN); Rahul Nadakuditi, Chennai (IN); Arun Sivasankar N, Chennai (IN)

(73) Assignee: Nokia Solutions and Networks Oy, Espoo (FI)

(21) Appl. No.: 18/353,372

(22) Filed: Jul. 17, 2023

(51) Int. Cl. H04W 16/26

(52) U.S. Cl. CPC H04W 16/26; H04W 84/12; H04W 88/08

(57) ABSTRACT

In a wireless network, such as a WiFi network, having a root node and at least one extender, as part of the execution of a factory reset of the root node, the root node automatically transmits a “clear configurations” message to each extender and, in response to receiving such message, each extender clears its configurations including any home SSIDs, any guest SSIDs, any gaming SSIDs, and any port-forwarding configurations. In this way, a factory reset of the root node can be used to prevent non-primary UEs from accessing the network using previous non-primary configurations.

### BACKGROUND

### Field of the Disclosure

The present disclosure relates to wireless networks and, more specifically but not exclusively, to WiFi networks having a root node and one or more extenders.

### Description of the Related Art

This section introduces aspects that may help facilitate a better understanding of the disclosure. Accordingly, the statements of this section are to be read in this light and are not to be understood as admissions about what is prior art or what is not prior art.

It is known for a WiFi network to be configured with a root node and one or more extenders that enable wireless user equipments (UEs) (e.g., laptops, mobile phones) to access the root node indirectly, thereby enabling the WiFi network to have a larger coverage zone. The primary UEs in such a WiFi network communicate wirelessly with the root node and/or extenders using a primary Service Set Identification (SSID) number. It is also known for a WiFi network to be configured with a guest SSID that enables non-primary UEs to access the WiFi network with, for example, limited capabilities and privileges. For example, if a guest is visiting a home having such a WiFi network, the homeowner may prefer to allow the guest's UE to access the WiFi network using only the guest SSID. The homeowner may attempt to prevent that guest's UE from accessing the WiFi network in the future by performing a factory reset of the root node, whereby the root node goes off and then on again, to clear the guest SSID from the WiFi network.

When the root node undergoes such a factory reset, any configurations (such as a guest SSID) previously set up at the root node will be cleared. The homeowner will then need to configure the root node with a new guest SSID, which is preferably different from the previous guest SSID. If, however, the WiFi network has an extender that was previously configured with the previous guest SSID, when the root node undergoes a factory reset, that previous guest SSID will remain configured at the extender, thereby enabling the guest's UE to access the WiFi network via the extender using that previous guest SSID even after the factory reset of the root node.

### SUMMARY

In certain embodiments, the present disclosure is a root node for a wireless network having an extender, the root node comprising communication hardware connected to a processor configured to cause the root node to transmit a message to the extender as part of a factory reset of the root node, wherein the message instructs the extender to clear its configurations.

In certain embodiments, the present disclosure is an extender for a wireless network having a root node, the extender comprising communication hardware connected to a processor configured to cause the extender to clear its configurations upon receiving a message from the root node instructing the extender to clear its configurations.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram of a basic WiFi network according to an embodiment of the disclosure;

FIG. 2 is a simplified block diagram showing the configuration of the WiFi network of FIG. 1 after the root node has undergone a conventional factory reset;

FIG. 3 is a simplified block diagram showing the configuration of the WiFi network of FIG. 1 after the root node has undergone a new factory reset of the present disclosure;

FIG. 4 is a flow diagram showing the operations involved in a new factory reset of the root node of FIGS. 1 and 3 with respect to one of the extenders, according to one embodiment of the present disclosure; and

FIG. 5 is a simplified hardware block diagram of an example node that can be used to implement any of the root node and the two extenders of FIGS. 1 and 3.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

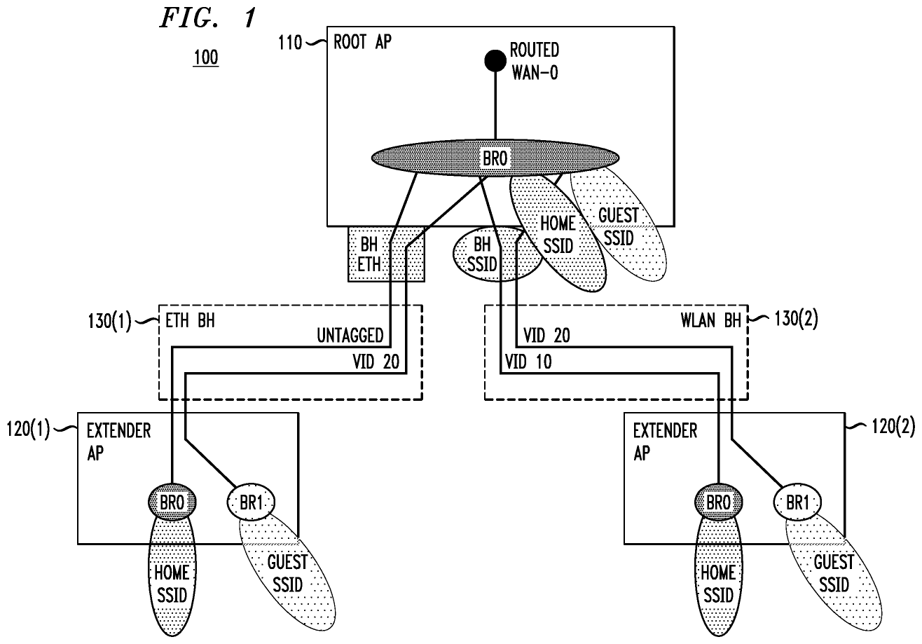

FIG. 1 is a simplified block diagram of a basic WiFi network 100 according to an embodiment of the disclosure. As shown in FIG. 1, WiFi network 100 has three wireless access points (APs): a root node 110 and two extenders 120(1) and 120(2), where the extender 120(1) communicates with the root node 110 via a wired Ethernet backhaul 130(1) and the extender 120(2) communicates with the root node 110 via a wireless WLAN backhaul 130(2) using a backhaul SSID.

The root node 110 and the two extenders 120 are configured with a primary (or home) SSID, which might or might not be the default primary SSID for the WiFi network, for use by primary UEs (not shown in FIG. 1) to communicate wirelessly with the WiFi network 100 either directly with the root node 110 or indirectly via one of the extenders 120. In addition, as shown in FIG. 1, the root node 110 and the two extenders 120 have also been configured with a guest SSID for use by non-primary (aka guest) UEs (not shown in FIG. 1) to communicate wirelessly with the WiFi network 100 either directly with the root node 110 or indirectly via one of the extenders 120.

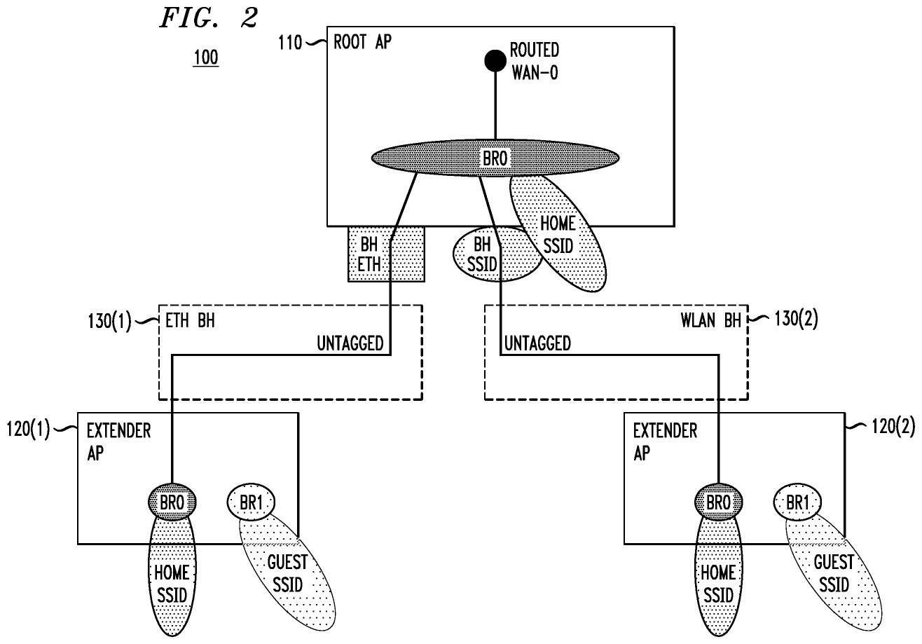

FIG. 2 is a simplified block diagram showing the configuration of the WiFi network 100 of FIG. 1 after the root node 110 has undergone a conventional factory reset. In this scenario, it is assumed that the home SSID of FIG. 1 is the default primary SSID for the WiFi network. As shown in FIG. 2, as a result of the conventional factory reset of the root node 110, the root node 110 will be automatically re-configured with its default home SSID, but not with the previous guest SSID. Nevertheless, since the extenders 120 are unaware of the conventional factory reset of the root node 110, both extenders 120 will retain the previous guest SSID of FIG. 1. As such, any UE that was previously able to access the WiFi network using the previous guest SSID will continue to be able to access the WiFi network 100 indirectly via either of the two extenders 120.

In order to avoid this situation, according to the present disclosure, the root node 110 supports a new factory reset mode during which the root node 110 transmits a “clear configurations” message to each extender 120 instructing the extender to clear its configurations, including any guest SSIDs. In response to receiving such a “clear configurations” message, according to the present disclosure, each extender 120 will clear its configurations, including any guest SSIDs. In certain implementations, the “clear configurations” message is defined under an existing WiFi communication standard and does not require modification of the standard itself. For example, for the IEEE 1905.1a WiFi standard, the “clear configurations” message may be an AP-AutoConfig WSC M2 message with a TLV type of “Clear Configurations identifier (0xXX)”, a TLV length value of 1, and a BootStrap value of 1. In other implementations, an existing WiFi communication standard is modified to support the “clear configurations” message. In other implementations, the BootStrap value can be programmed to clear all configurations (value 1), only guest SSIDs (value 2), or only gaming SSIDs (value 3) at the extenders 120.

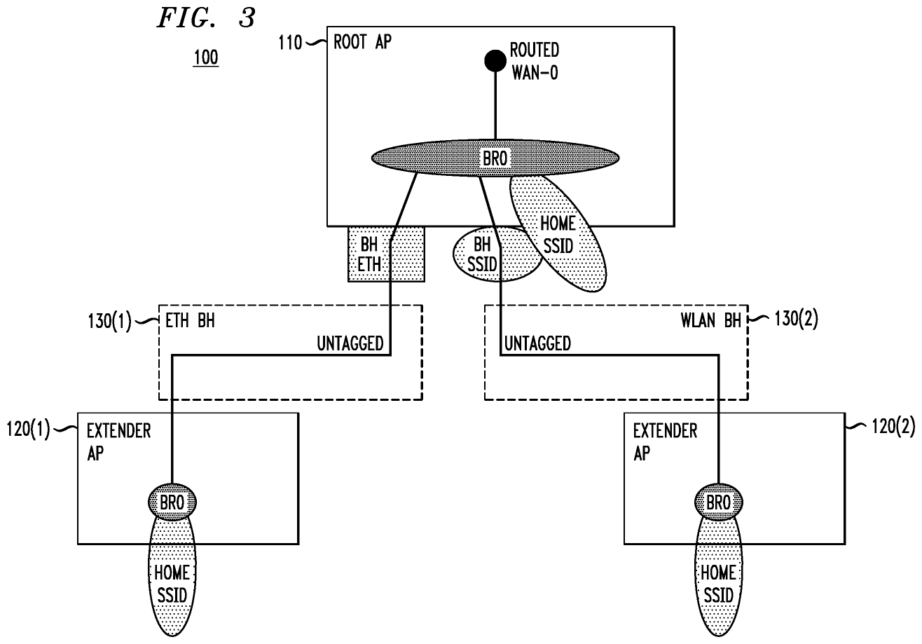

FIG. 3 is a simplified block diagram showing the configuration of the WiFi network 100 of FIG. 1 after the root node 110 has undergone a new factory reset of the present disclosure. As shown in FIG. 3, as a result of the new factory reset, the root node 110 will be automatically re-configured with its default home SSID, but not with the previous guest SSID. Note that, whether or not the previous home SSID of FIG. 1 was the default home SSID, the root node 110 will be re-configured with the default home SSID as a result of the new factory reset, the same as with a conventional factory reset.

Furthermore, as a result of receiving a “clear configurations” message from the root node 110, each extender 120 will clear its configurations, including the previous home SSID and any previous guest SSID. Each extender 120 will then have to re-execute a conventional onboarding procedure to re-acquire the default home SSID from the root node 110, but not the previous guest SSID, which no longer exists at the root node 110.

As a result of the new factory reset mode for the root node 110, any UE that was previously able to access the WiFi network using the previous guest SSID will no longer be able to access the WiFi network 100, not directly with the root node 110 and not indirectly via either of the two extenders 120. To enable future guests' UEs to access the WiFi network 100, the homeowner will need to configure the root node 110 and extenders 120 with a new (preferably different) guest SSID.

FIG. 4 is a flow diagram showing the operations involved in a new factory reset of the root node 110 of FIGS. 1 and 3 with respect to each extender 120, according to one embodiment of the present disclosure. In step 402, the homeowner initiates a factory reset of the root node 110, for example, by using the root node's graphical user interface or a mobile application that accesses the root node 110. As part of the factory reset, in step 404, the configurations, including the previous home SSID and any previous guest SSID, are cleared at the root node 110, but not at the extender 120, which will retain the previous home SSID and any previous guest SSID. In step 406, as part of the factory reset, the root node 110 is automatically re-configured with its default home SSID.

If the default home SSID is different from the previous home SSID, then each extender 120, which retains the previous home SSID, will be unable to communicate with the root node 110, which has been re-configured with the default home SSID. In that case, in step 408, the extender 120 initiates an onboarding procedure to re-connect with the root node 110 by sending an autoconfig search message to the root node 110, and, in response, in step 410, the root node 110 sends an autoconfig response message to the extender 120 in which the root node 110 provides the default home SSID to the extender 120. In step 412, the extender 120 sends an autoconfig message to the root node 110 in which the extender 120 provides its capabilities to the root node 110. Note that, if the default home SSID is the same as the previous home SSID, then, following the factory reset of the root node 110, each extender 120 will be able to continue to communicate with the root node 110 using the previous home SSID. In that case, steps 408-412 will be omitted.

In step 414, as part of the factory reset of the root node 110, the root node 110 sends a “clear configurations” message to the extender 120, and, in response, in step 416, the extender 120 clears its configurations including the home SSID and any previous guest SSID of FIG. 1. As such, in step 418, the onboarding procedure of steps 408-412 will then be performed/repeated to re-configure the extender 120 to communicate with the root node 110 using the default home SSID. Note that the onboarding process does not involve automatically providing a guest SSID to the extender 120. Furthermore, at this point, as a result of the factory reset of the root node 110, the root node 110 will not be configured with any guest SSID. Instead, the homeowner will have to manually re-configure the root node 110 and any extender 120 with a new guest SSID.

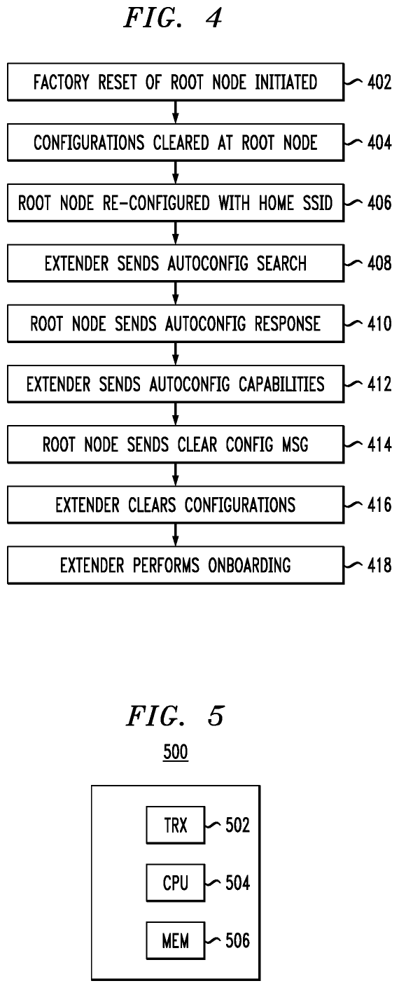

FIG. 5 is a simplified hardware block diagram of an example node 500 that can be used to implement any of the root node 110 and the two extenders 120 of FIGS. 1 and 3. As shown in FIG. 5, the node 500 includes (i) communication hardware (e.g., wireless, wireline, and/or optical transceivers (TRX)) 502 that supports communications with other nodes, (ii) a processor (e.g., CPU microprocessor) 504 that controls the operations of the node 500, and (iii) a memory (e.g., RAM, ROM) 506 that stores code executed by the processor 504 and/or data generated and/or received by the node 500.

Although the present disclosure has been described in the context of extenders clearing home SSIDs and guest SSIDs upon receiving a “clear configurations” message from the root node, in general, the “clear configurations” message may apply to any extender configurations, including (without limitation) gaming SSIDs, secondary home SSIDs, and port-forwarding configurations in addition to guest SSIDs.

Although the present disclosure has been described in the context of WiFi networks conforming to the IEEE 1905.1a WiFi standard, those skilled in the art will understand that the present disclosure can be implemented in the context of other suitable wireless networks.

In certain embodiments, the present disclosure is a root node for a wireless network having an extender, the root node comprising communication hardware connected to a processor configured to cause the root node to transmit a message to the extender as part of a factory reset of the root node, wherein the message instructs the extender to clear its configurations.

In at least some of the above embodiments, as part of the factory reset of the root node, the root node is configured to clear its configurations and be automatically re-configured with its default home SSID.

In certain embodiments, the present disclosure is an extender for a wireless network having a root node, the extender comprising communication hardware connected to a processor configured to cause the extender to clear its configurations upon receiving a message from the root node instructing the extender to clear its configurations.

In at least some of the above embodiments, upon receiving the message from the root node, the extender is configured to clear any guest SSIDs, any home SSIDs, any gaming SSIDs, and any port-forwarding configurations.

In at least some of the above embodiments, upon clearing its configurations, the extender is configured to automatically perform an onboarding procedure with the root node to acquire a home SSID from the root node.

In at least some of the above embodiments, the wireless network is a WiFi network.

In at least some of the above embodiments, the WiFi network conforms to an IEEE 1905.1a standard.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A root node for a wireless network having an extender, the root node comprising communication hardware connected to a processor configured to cause the root node to transmit a message to the extender as part of a factory reset of the root node, wherein the message instructs the extender to clear its configurations.

2. The root node of claim 1, wherein, as part of the factory reset of the root node, the root node is configured to clear its configurations and be automatically re-configured with its default home SSID.

3. The root node of claim 1, wherein the wireless network is a WiFi network.

4. The root node of claim 3, wherein the WiFi network conforms to an IEEE 1905.1a standard.

5. A method for a root node in a wireless network having an extender, the method comprising the root node transmitting a message to the extender as part of a factory reset of the root node, wherein the message instructs the extender to clear its configurations.

6. The method of claim 5, wherein, as part of the factory reset of the root node, the root node clears its configurations and is automatically re-configured with its default home SSID.

7. The method of claim 5, wherein the wireless network is a WiFi network.

8. The method of claim 7, wherein the WiFi network conforms to an IEEE 1905.1a standard.

9. An extender for a wireless network having a root node, the extender comprising communication hardware connected to a processor configured to cause the extender to clear its configurations upon receiving a message from the root node instructing the extender to clear its configurations.

10. The extender of claim 9, wherein, upon receiving the message from the root node, the extender is configured to clear any guest SSIDs, any home SSIDs, any gaming SSIDs, and any port-forwarding configurations.

11. The extender of claim 9, wherein, upon clearing its configurations, the extender is configured to automatically perform an onboarding procedure with the root node to acquire a home SSID from the root node.

12. The extender of claim 9, wherein the wireless network is a WiFi network.

13. The extender of claim 12, wherein the WiFi network conforms to an IEEE 1905.1a standard.

14. A method for an extender in a wireless network having a root node, the method comprises the extender clearing its configurations upon receiving a message from the root node instructing the extender to clear its configurations.

15. The method of claim 14, wherein, upon receiving the message from the root node, the extender clears any guest SSIDs, any home SSIDs, any gaming SSIDs, and any port-forwarding configurations.

16. The method of claim 14, wherein, upon clearing its configurations, the extender automatically performs an onboarding procedure with the root node to acquire a home SSID from the root node.

17. The method of claim 14, wherein the wireless network is a WiFi network.

18. The method of claim 17, wherein the WiFi network conforms to an IEEE 1905.1a standard.
